(19) United States
(12) Patent Application Publication
(10) Pub. No.: US 2026/0030348 A1
(43) Pub. Date: Jan. 29, 2026

(54) EVENT DETECTION MODEL

(71) Applicant: CrowdStrike, Inc., Sunnyvale, CA (US)

(72) Inventors: Daniel Brown, Ipswich, MA (US); Johnathan Hoyt, Reading, MA (US); Sseziwa Mukasa, Salem, MA (US); Rico Valdez, Albuquerque, NM (US); Thomas Hobson, Brookline, MA (US)

(21) Appl. No.: 18/928,994

(22) Filed: Oct. 28, 2024

Related U.S. Application Data
(60) Provisional application No. 63/676,661, filed on Jul. 29, 2024.

(51) Int. Cl. G06F 21/55

(52) U.S. Cl. CPC G06F 21/554

(57) ABSTRACT

The present disclosure provides techniques for event detection. A processing device computes a first score corresponding to an event at a first host based on a first timestamp of the event, a second timestamp, and a base rate. The processing device computes, based on the first score exceeding a first threshold value, a second score based on: the first timestamp, a third timestamp corresponding to an occurrence of the event at a second host, and the base rate. The processing device outputs an indication of the event based on the first score and the second score.

### CROSS-REFERENCE TO RELATED APPLICATIONS

This application claims priority to U.S. Provisional Patent Application No. 63/676,661, filed on Jul. 29, 2024, and entitled “EVENT DETECTION MODEL”, the entirety of which is incorporated herein by reference.

### TECHNICAL FIELD

Aspects of the present disclosure relate to cybersecurity, and more particularly, to an event detection model.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example of a system for event detection in accordance with some aspects of the present disclosure.

FIG. 2A is a diagram illustrating an example of a timeline of events in accordance with some aspects of the present disclosure.

FIG. 2B is a diagram illustrating an example of multi-level scoring in accordance with some aspects of the present disclosure.

FIG. 3 is a flow diagram of a method of event detection in accordance with some aspects of the present disclosure.

FIG. 4 is a flow diagram of a method of event detection in accordance with some aspects of the present disclosure.

FIG. 5 is a block diagram that illustrates an example of a system for event detection in accordance with some aspects of the present disclosure.

FIG. 6 illustrates a diagrammatic representation of a machine in an example form of a computer system that may perform one or more of the operations described herein in accordance with some aspects of the present disclosure.

### DETAILED DESCRIPTION

Indicators of attack (IOAs) may detect suspicious behavior (i.e., evidence of an attacker's intent to carry out a cyberattack); however, this behavior is often performed on uncompromised endpoints for benign purposes (e.g., the first time a user logs on to a host). Analysts may sort through high volumes of IOAs to determine which IOAs are to be investigated further. Furthermore, the analysts may attempt to differentiate between benign background noise that typically occurs on endpoints from new and surprising IOAs that are more likely to be malicious and hence worthy of further investigation.

Several approaches exist for handling IOAs; however, such approaches suffer from various shortcomings. In one approach, a (definition of) an IOA is narrowed such that the IOA has a high efficacy rate and thus rarely triggers in benign cases. This approach may hinder the IOA such that the IOA detects a portion of behaviors that the IOA is intended to cover and not all behaviors that the IOA is intended to cover. In another approach, benign occurrences of an IOA may be whitelisted. However, this approach may be costly and infeasible to scale over many thousands of detections and endpoints. In yet another approach, the IOA may be left “as is” to cover a desired behavior. However, in this approach, a user/analyst may be left to sort through noise. In a further approach, an IOA may be detected based on a “first seen” heuristic. However, this approach may not be useful in certain instances, such as when a new employee logs onto a host, as (virtually) all new employees log on to a host when starting a new position.

The present disclosure addresses the above-noted and other deficiencies by using a processing device to detect and score IOAs. In one aspect, a processing device tracks how frequently IOAs trigger at endpoints within an enterprise environment. The processing device assigns a score representing a statistical surprisal of the IOA. In an example, if an IOA regularly triggers on an endpoint (i.e., a host), the IOA may receive a low score and the IOA can be hidden from or deprioritized from users. However, if an IOA occurs on an endpoint that the IOA has never or has rarely been observed on, the IOA may receive a high score and be shown to and prioritized for the user. In one aspect, the processing device may track how frequently IOAs trigger at endpoints across an enterprise network. If an IOA triggers frequently on endpoints across the network, the IOA is likely to receive a low score, whereas if the IOA is rare across endpoints across the network, the IOA is likely to receive a high score. The present disclosure allows for detection engineers to create general IOAs that more accurately capture suspicious behavior without having to narrow detection parameters, excessively whitelist IOAs, or push a noise issue to a user. The present disclosure may handle raw IOAs and identify surprising occurrences, while ignoring repetitive, noisy occurrences. In one aspect, a weight model and components associated with the weight model track IOAs at individual endpoints and at all endpoints on a network. A weight assigned for an individual endpoint may be combined with a weight relative to all endpoints on a network in order to arrive at a single score for statistical surprisal.

In an example, a processing device computes a first score corresponding to an event at a first host based on a first timestamp of the event, a second timestamp, and a base rate. The processing device computes, based on the first score exceeding a first threshold value, a second score based on: the first timestamp, a third timestamp corresponding to an occurrence of the event at a second host, and the base rate. The processing device outputs an indication of the event based on the first score and the second score.

As discussed herein, the present disclosure provides an approach that improves the operation of a computer system by automatically detecting surprising events (e.g., IOAs) on hosts (e.g., endpoints). For instance, vis-à-vis “computing a first score corresponding to an event at a first host based on a first timestamp of the event, a second timestamp, and a base rate” and “computing, based on the first score exceeding a first threshold value, a second score based on: the first timestamp, a third timestamp corresponding to an occurrence of the event at a second host, and the base rate,” the present disclosure may enable the accurate detection of events (e.g., IOAs) without the computer system having to sort through noise. In addition, the present disclosure provides an improvement to the technological field of cybersecurity by improving the detection of events (e.g., IOAs) on hosts. For instance, vis-à-vis “computing a first score corresponding to an event at a first host based on a first timestamp of the event, a second timestamp, and a base rate” and “computing, based on the first score exceeding a first threshold value, a second score based on: the first timestamp, a third timestamp corresponding to an occurrence of the event at a second host, and the base rate,” the present disclosure may enable events to be detected without having to narrow IOA definitions, without having to whitelist IOAs, and/or without having an analyst sort through noise.

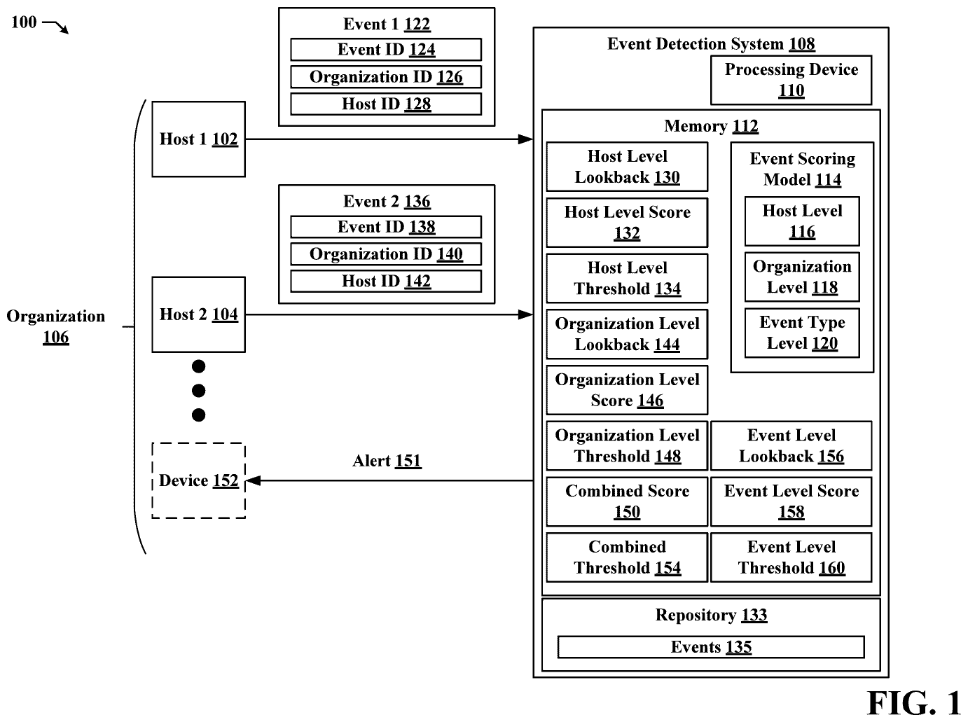

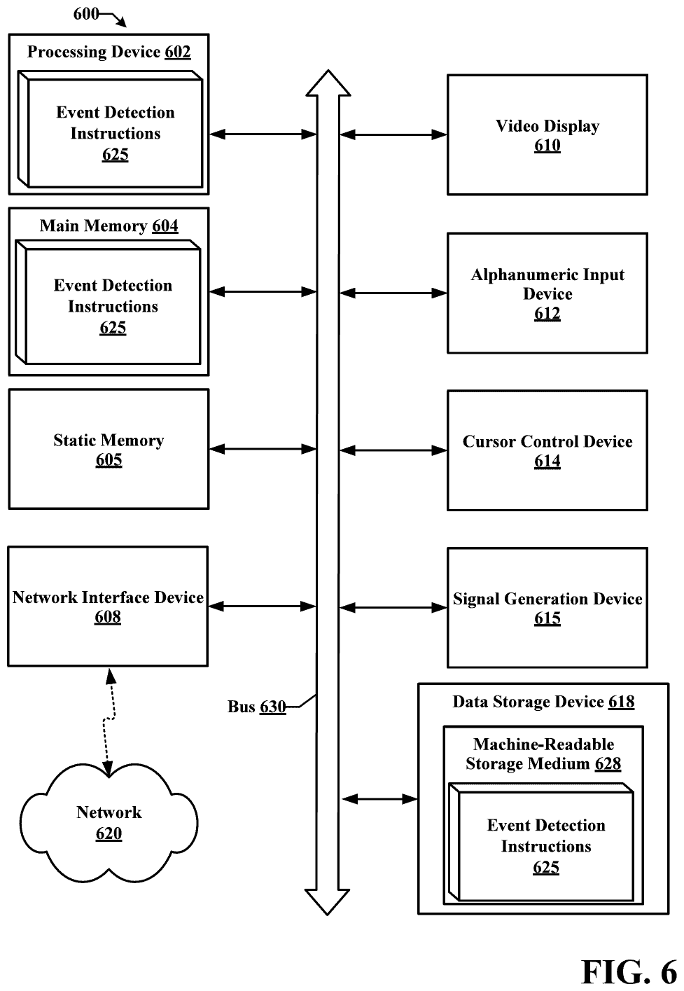

FIG. 1 is a block diagram 100 that illustrates an example of a system for event detection in accordance with some aspects of the present disclosure. The system includes a first host 102 and a second host 104. The first host 102 and the second host 104 may be or include a computing device. In an example, the computing device may be or include a desktop computing device, a laptop computing device, a tablet computing device, a smartphone, a wearable computing device, and/or a server. In an example, the first host 102 and/or the second host 104 may be or include the machine depicted in FIG. 6. For instance, the first host 102 and/or the second host 104 may include processing devices, memory, etc.

The first host 102 and the second host 104 may belong to/be owned by/be maintained by an organization 106. In an example, the organization 106 may be a corporation, a government entity, etc.

The system further includes an event detection system 108. As will be described in greater detail below, the event detection system 108 is generally configured to detect events, score the events, and output indications of the events. The event detection system 108 may include a processing device 110 and memory 112. In some aspects, the event detection system 108 belongs to/is owned by/is maintained by the organization 106. In other aspects, the event detection system 108 is under control of an organization that is separate from the organization 106, where the organization provides cybersecurity services to the organization 106. In some aspects, the event detection system 108 may be implemented at the first host 102 and/or the second host 104. In some aspects, the event detection system 108 may be implemented at a server.

The memory 112 of the event detection system 108 may store an event scoring model 114 that is configured to assign scores to events. The event scoring model 114 may be a multi-level scoring model (i.e., a multi-level signal weighting model). In some aspects, the scores may be referred to as weights. The event scoring model 114 may include a host level 116 that is configured to assign scores to events at a host level (e.g., at the first host 102). The event scoring model 114 may include an organization level 118 that is configured to assign scores to events at an organization level (e.g., across the organization 106). The event scoring model 114 may include an event type level 120 that is configured to assign scores to events at an event type level (e.g., across more than one organization).

In an example, an event detected by the event detection system 108 may be or include an IOA. An IOA may refer to evidence of an attacker's intent to carry out a cyberattack. An IOA may show techniques used by an attacker to achieve a goal of the attacker. In another example, the event detected by the event detection system 108 may be or include an indicator event or a detect event. An indicator event may refer to at event generated by a sensor running on a host. An indicator event may correspond to an event with a relatively low fidelity (i.e., unlikely to be an IOA). A detect event may correspond to an event with a relatively high fidelity (i.e., likely to be an IOA).

As the first host 102 operates, a first event 122 may occur at the first host 102. In an example, the first event 122 may be writing files to a temporary directory of the first host 102. In an example, the event detection system 108 may obtain an event stream associated with the first event 122. The event stream may also be associated with other events occurring at the first host 102 or other hosts. In some aspects, the event detection system 108 may sample the event stream to obtain an indication of the first event 122. In an example, the event stream may include an indication of the first event 122, where the indication of the first event 122 includes an event identifier (ID) 124 of the first event 122, an organization ID 126 of the organization 106, and a host ID 128 of the first host 102. The event ID 124 may be indicative of a type of the first event 122. The event detection system 108 may perform a “groupBy” operation in order to split the event stream such that events with the same values (e.g., the event ID 124, the organization ID 126, and/or the host ID 128) are processed in the same context. The “groupBy” operation may facilitate filtering of events. In some aspects, some of the “groupBy” operation may be performed by the first host 102.

The indication of the first event 122 may also include a first timestamp (e.g., a date and a time) at which the first event 122 occurs. In one aspect, the first timestamp is added by the first host 102. In another aspect, the first timestamp is added by an upstream event handler (not depicted in FIG. 1). In a further aspect, the first timestamp is added by the event detection system 108 when the event detection system 108 obtains the indication of the first event 122. In some aspects, the event detection system 108 may detect an occurrence of the first event 122 based on the indication of the first event 122.

The event detection system 108 may compute a host level lookback 130 based on the first timestamp and a second timestamp. The host level lookback 130 may be a difference between the first timestamp and the second timestamp (or a difference between the second timestamp and the first timestamp).

In one aspect, the event detection system 108, via the host level 116, determines that an event corresponding to the first event 122 has previously occurred on the first host 102. For instance, the event detection system 108 may include or be associated with a repository 133 that stores indications of events 135 (which may include event IDs, organization IDs, host IDs, and timestamps corresponding to the events 135). Although the repository 133 is depicted as being part of the event detection system 108, in some aspects, the repository 133 may be separate from the event detection system 108 and communicatively coupled to the event detection system 108. The event detection system 108 may execute a search over the indications based on the host ID 128 and the event ID 124. The search may produce search results that include a second timestamp for a previous occurrence of the first event 122 at the first host 102. In such an aspect, the event detection system 108, via the host level 116, computes a difference between the first timestamp and the second timestamp corresponding to the previous occurrence of the first event 122 at the first host 102. In an example, the host level lookback 130 may be a time delta.

In some aspects, the first event 122 may not have previously occurred on the first host 102. In such an aspect, the second timestamp may be a time at which the first host 102 was activated (i.e., a host or an entity origination time). In such an aspect, the event detection system 108 may compute the host level lookback 130 based on a minimum of: a difference between the first timestamp and a timestamp corresponding to a previous occurrence of the first event 122 at the first host and a difference between the first timestamp and a timestamp corresponding to a time at which the first host 102 was activated.

In some aspects, the event detection system 108 may have operated for less time than the first host 102. In such an aspect, the host level lookback 130 may be limited to a time at which the event detection system 108 began operation. In such an aspect, the event detection system 108 may compute the host level lookback 130 based on a minimum of: a difference between the first timestamp and a timestamp corresponding to a time at which the first host 102 was activated and a timestamp corresponding to a time at which the event detection system 108 began operation.

The event detection system 108, via the host level 116, may compute a host level score 132 (which may also be referred to as a host level weight) for the first event 122 at the first host 102 based on a logarithm of the host level lookback 130 and a base rate (i.e., a fixed time interval). The base rate enables the determination of zero on a Y log scale axis and normalizes events. This approach may produce a metric (i.e., a score) that is uniform and equally applicable to login events and IOAs firing on an endpoint. The base rate may also enable scores to be combined into incidents (i.e., incident scores). In an example, the base rate is one day, six hours, one hour, etc.

In general, when the host level score 132 is relatively high, the first event 122 has not occurred relatively recently at the first host 102, whereas when the host level score 132 is relatively low, the first event 122 has occurred relatively recently at the first host 102). Stated differently, the host level score 132 may answer the question: “how unusual is this behavior (i.e., the first event 122) at the first host 102 (e.g., an endpoint).”

The event detection system 108, via the host level 116, may compare the host level score 132 to a host level threshold 134. In an example, the host level threshold 134 may be zero. If the host level score 132 is less than the host level threshold 134, the event detection system 108 may drop the first event 122. For instance, the event detection system 108 may not perform further processing with respect to the first event 122 other than storing the indication of the first event 122 in the repository 133. If the host level score 132 is greater than or equal to the host level threshold 134, the event detection system 108 may perform further processing (described below). The event detection system 108 may also store the indication of the first event 122 in the repository 133.

The event detection system 108, via the organization level 118, may determine whether a first event 122 has previously occurred at another host of the organization 106 (i.e., whether a type of the first event 122 has previously occurred at another host of the organization 106). In an example, a second event 136 has previously occurred at the second host 104, where the second event 136 is of the same type as the first event 122. As such, the repository 133 may store an indication of the second event 136, including an event ID 138 of the second event 136, an organization ID 140 of the organization 106, and a host ID 142 of the second event 136. In an example, the event ID 124 and the event ID 138 are equal and the organization ID 126 and the organization ID 140 are equal. The event detection system 108 may execute a search over the indications of events 135 in the repository 133 based on the event ID 124 and the organization ID 140. The search may produce search results, where the search results may include the indication of the second event 136. The indication of the second event 136 may include a third timestamp corresponding to a time at which the second event 136 occurred at the second host 104.

The event detection system 108, via the organization level 118, may compute an organization level lookback 144, where the organization level lookback 144 is a difference between the first timestamp and the third timestamp.

The event detection system 108, via the organization level 118, may compute an organization level score 146 based on a logarithm of the organization level lookback 144 and the base rate. The organization level score 146 may answer the question: “how unusual is the first event across an organization?”

In some aspects, the event detection system 108, via the organization level 118, may compare the organization level score 146 to an organization level threshold 148. If the organization level score 146 is less than the organization level threshold 148, the event detection system 108 may drop the first event 122. If the organization level score 146 is greater than the organization level threshold 148, the event detection system 108 may perform further processing. For instance, the event detection system 108 may transmit an alert 151 to a device 152. The alert 151 may indicate that a (likely) cyberattack has been detected. In an example, the device 152 may be the first host 102 or another host of the organization 106. The device 152 may present the alert 151 to a user (e.g., via a display of the device 152).

In some aspects, the event detection system 108 may combine the host level score 132 and the organization level score 146 to generate a combined score 150. For instance, the event detection system 108 may add the host level score 132 and the organization level score 146 to generate the combined score 150. The event detection system 108 may compare the combined score 150 to a combined threshold 154. If the combined score 150 is less than the combined threshold 154, the event detection system 108 may drop the first event 122. If the combined score 150 is greater than or equal to the combined threshold 154, the event detection system 108 may transmit the alert 151 to the device 152.

Although the description above has focused on detection of events at a host level and at an organization level, other possibilities are contemplated. In some aspects, the event detection system 108, via the event type level 120, determines whether the first event 122 (i.e., a type of the first event) has occurred previously across different organizations. The event detection system 108, via the event type level 120, computes an event level lookback 156 in a manner similar to that described above with respect to the organization level lookback 144, where the event level lookback 156 accounts for events across different organizations. The event detection system 108, via the event type level 120, computes an event level score 158 in a manner similar to that described above with respect to the organization level score 146. For instance, the event detection system 108, via the event type level 120, computes the event level score 158 based on a logarithm of the event level lookback 156 and the base rate.

The event detection system 108, via the event type level 120, may compare the event level score 158 to an event level threshold 160. If the event level score 158 is less than the event level threshold 160, the event detection system 108 may drop the first event 122. If the event level score 158 is greater than or equal to the event level threshold 160, the event detection system 108 may transmit the alert 151 to the device 152.

In some aspects, the event detection system 108 may combine the host level score 132, the organization level score 146, and the event level score 158 to produce the combined score 150. For instance, the event detection system 108 may add the host level score 132, the organization level score 146, and the event level score 158 to produce the combined score 150. The event detection system 108 may compare the combined score 150 to the combined threshold 154. If the combined score 150 is less than the combined threshold 154, the event detection system 108 may drop the first event 122. If the combined score 150 is greater than or equal to the combined threshold 154, the event detection system 108 may transmit the alert 151 to the device 152.

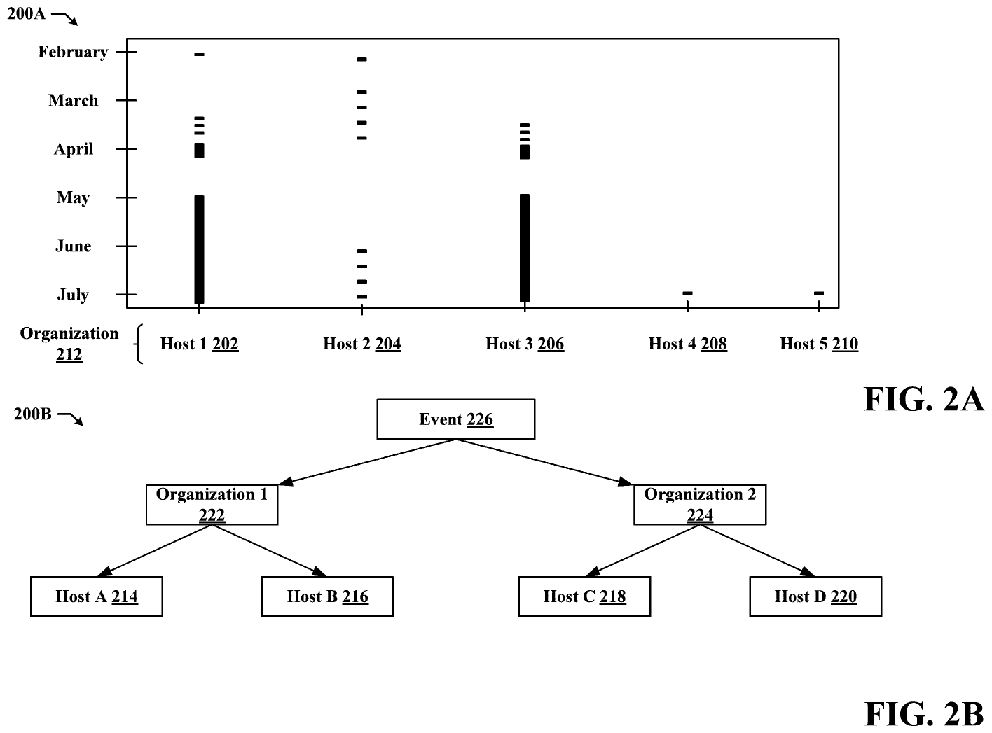

FIG. 2A is a diagram 200A illustrating an example of a timeline of events in accordance with some aspects of the present disclosure. The timeline may be associated with the system described above in FIG. 1. For instance, the event detection system 108 may generate the timeline. The timeline, on the horizontal axis, depicts a first host 202, a second host 204, a third host 206, a fourth host 208, and a fifth host 210 that belong to an organization 212. The timeline, on the vertical axis, depicts the months of February, March, April, May, June, and July. Event detections are indicated by darkened rectangles in the timeline. In an example, the first host 202 may be or include the first host 102, the second host 204 may be or include the second host 104, and the organization 212 may be or include the organization 106.

In an example, the event detection system 108 may “whitelist” events corresponding to the first host 202, the second host 204, and the third host 206 due to the repetition of a particular pattern at the first host 202, the second host 204, and the third host 206. For instance, the event detection system 108 may drop the aforementioned events as described above. In an example, the event detection system 108 may transmit an alert (e.g., the alert 151) corresponding to the event at the fourth host 208, as the event is unusual.

FIG. 2B is a diagram 200B illustrating an example of multi-level scoring in accordance with some aspects of the present disclosure. The diagram 200B depicts host A 214, host B 216, host C 218, host D 220, organization 1 222, organization 2 224, and event 226. Host A 214 and host B 216 are associated with organization 1 222. Host C 218 and host D 220 are associated with organization 2 224. Organization 1 222 and organization 2 224 are associated with event 226. In an example, host A 214 may be or include the first host 102, host B 216 may be or include the second host 104, and organization 1 222 may be or include the organization 106. As described above, the event detection system 108 may generate scores for host A 214, host B 216, host C 218, host D 220, organization 1 222, organization 2 224, and event 226.

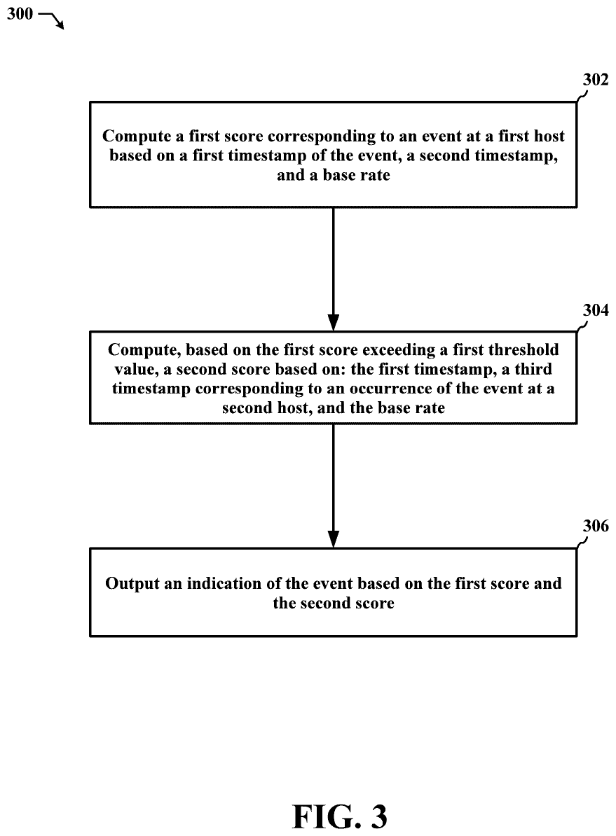

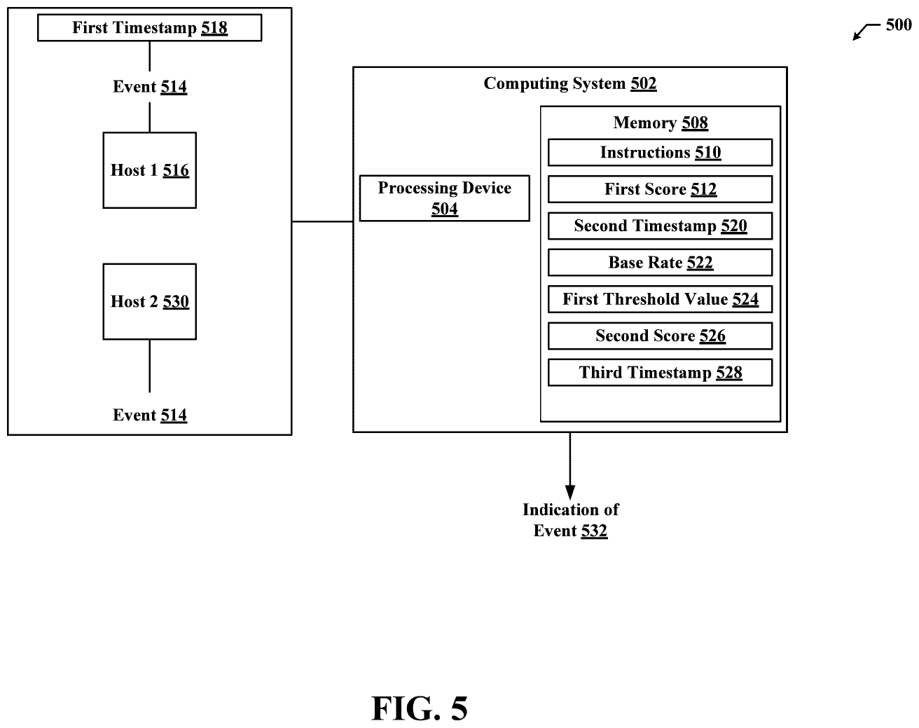

FIG. 3 is a flow diagram 300 of a method for event detection in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the processing device 110 (shown in FIG. 1), the processing device 504 (shown in FIG. 5), the processing device 602 (shown in FIG. 6), or a combination thereof.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

At block 302, a processing device computes a first score corresponding to an event at a first host based on a first timestamp of the event, a second timestamp, and a base rate. For example, the first score may be the host level score 132, the first host may be the first host 102, the event may be the first event 122. In another example, the first score may be the first score 512, the event may be the event 514, the first host may be the first host 516, the first timestamp may be the first timestamp 518, the second timestamp may be the second timestamp 520, and the base rate may be the base rate 522.

At block 304, the processing device computes, based on the first score exceeding a first threshold value, a second score based on: the first timestamp, a third timestamp corresponding to an occurrence of the event at a second host, and the base rate. In an example, the second host may be the second host 104 and the second score may be the organization level score 146. In an example, the first threshold value may be the first threshold value 524, the third timestamp may be the third timestamp 528, the second host may be the second host 530, and the second score may be the second score 526.

At block 306, the processing device outputs an indication of the event based on the first score and the second score. In an example, the indication of the event may be the indication of the event 532.

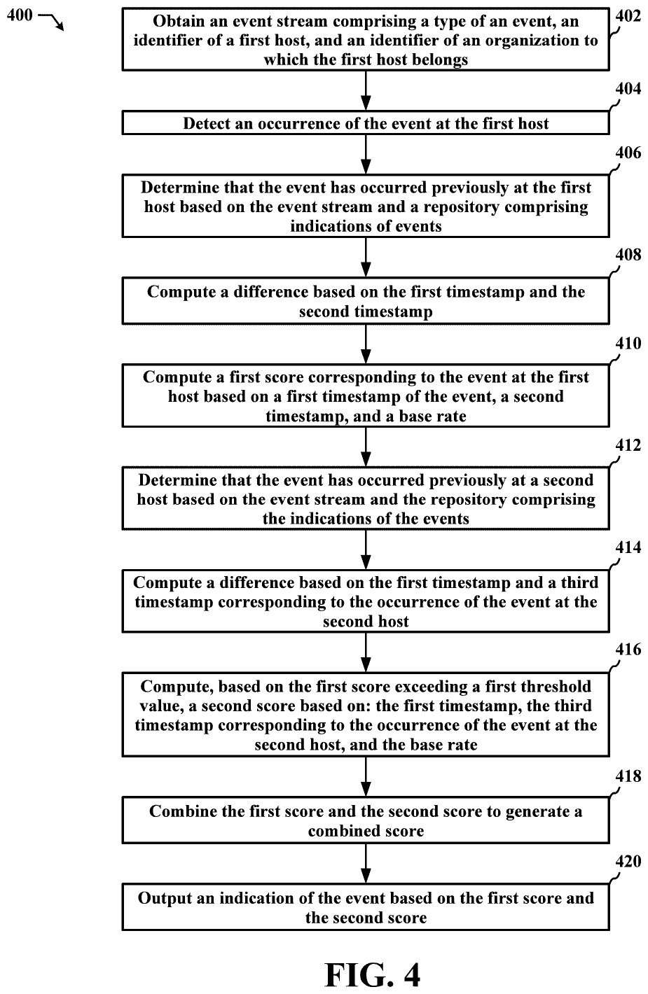

FIG. 4 is a flow diagram 400 of a method for event detection in accordance with some aspects of the present disclosure. The method may be performed by processing logic that may include hardware (e.g., a processing device), software (e.g., instructions running/executing on a processing device), firmware (e.g., microcode), or a combination thereof. In some aspects, at least a portion of the method may be performed by the processing device 110 (shown in FIG. 1), the processing device 504 (shown in FIG. 5), the processing device 602 (shown in FIG. 6), or a combination thereof.

At block 402, a processing device may obtain an event stream including a type of an event, an identifier of a first host, and an identifier of an organization to which the first host belongs. In an example, the type of the event may correspond to the event ID 124, the identifier of the first host may correspond to the host ID 128, and the identifier of the organization may correspond to the organization ID 126. In some aspects, the first host may be or include a server or a user device. In some aspects, the event may be in an indicator event or a detect event.

At block 404, the processing device may detect an occurrence of the event at the first host. For example, the event detection system 108 may detect an occurrence of the event at the first host.

At block 406, the processing device may determine that the event has occurred previously at the first host based on the event stream and a repository comprising indications of events. For example, the repository may be the repository 133.

At block 408, the processing device may compute a difference based on the first timestamp and the second timestamp. For example, the difference may correspond to the host level lookback 130.

At block 410, the processing device computes a first score corresponding to the event at the first host based on a first timestamp of the event, a second timestamp, and a base rate. For example, the first score may be the host level score 132, the first host may be the first host 102, the event may be the first event 122. In another example, the first score may be the first score 512, the event may be the event 514, the first host may be the first host 516, the first timestamp may be the first timestamp 518, the second timestamp may be the second timestamp 520, and the base rate may be the base rate 522. In some aspects, computing the first score may be based on the difference between the first timestamp and the second timestamp. In some aspects, computing the first score may include computing a logarithm of a quotient of the difference and the base rate. In some aspects, the first score is indicative of a recentness of the event occurring at the first host. In an example, the second timestamp corresponds to at least one of a second occurrence of the event at the first host, a time at which the first host was activated, or a time at which an event detection system was activated.

At block 412, the processing device may determine that the event has occurred previously at a second host based on the event stream and the repository comprising the indications of the events. For example, the second host may be the second host 104 or the second host 530. In some aspects, the first host and the second host belong to a (same) organization.

At block 414, the processing device may compute a difference based on the first timestamp and a third timestamp corresponding to the occurrence of the event at the second host. In an example, the third timestamp may be the third timestamp 528. In an example, the difference may correspond to the organization level lookback 144.

At block 416, the processing device computes, based on the first score exceeding a first threshold value, a second score based on: the first timestamp, the third timestamp corresponding to the occurrence of the event at the second host, and the base rate. In an example, the second host may be the second host 104 and the second score may be the organization level score 146. In an example, the first threshold value may be the first threshold value 524, the third timestamp may be the third timestamp 528, the second host may be the second host 530, and the second score may be the second score 526. In some aspects, computing the second score may be based on the difference between the first timestamp and the third timestamp. In some aspects, computing the second score may include computing logarithm of a quotient of the difference and the base rate. In some aspects, the second score is indicative of a recentness of the event occurring with an organization.

At block 418, the processing device may combine the first score and the second score to generate a combined score. For example, the combined score may be the combined score 150.

At block 420, the processing device outputs an indication of the event based on the first score and the second score. In an example, the indication of the event may be the indication of the event 532. In some aspects, outputting the indication of the event may include transmitting the indication of the event for presentation in a UI. In some aspects, outputting the indication of the event may include outputting the indication of the event based on the combined score exceeding a second threshold value. In some aspects, the second threshold value may be the organization level threshold 148.

The method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

FIG. 5 is a block diagram 500 that illustrates an example of a computing system 502 for event detection in accordance with some aspects of the present disclosure. In some aspects, the computing system 502 may perform some or all of the functionality described herein. The computing system 502 includes a processing device 504 and memory 508. The memory 508 stores instructions 510 that are executed by the processing device 504. The instructions 510, when executed by the processing device 504, cause the processing device 504 to perform a methodology described herein.

In an example, the processing device 504 computes a first score 512 corresponding to an event 514 at a first host 516 based on a first timestamp 518 of the event 514, a second timestamp 520, and a base rate 522. The processing device 504 computes, based on the first score 512 exceeding a first threshold value 524, a second score 526 based on: the first timestamp 518, a third timestamp 528 corresponding to an occurrence of the event 514 at a second host 530, and the base rate 522. The processing device 504 outputs an indication of the event 532 based on the first score 512 and the second score 526.

FIG. 6 illustrates a diagrammatic representation of a machine in the example form of a computer system 600 within which a set of instructions, for causing the machine to perform any one or more of the methodologies discussed herein for event detection.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, the computer system 600 may be representative of a server.

The computer system 600 includes a processing device 602, a main memory 604 (e.g., read-only memory (ROM), flash memory, dynamic random access memory (DRAM), a static memory 605 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 600 may further include a network interface device 608 which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 615 (e.g., an acoustic signal generation device, such as a speaker). In some embodiments, the video display unit 610, the alphanumeric input device 612, and the cursor control device 614 may be combined into a single component or device (e.g., an LCD touch screen).

The processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device 602 may also be one or more special-purpose processing devices such as an application specific integrated circuit (ASIC), a field programmable gate array (FPGA), a digital signal processor (DSP), network processor, or the like. The processing device 602 is configured to execute event detection instructions 625, for performing the operations and steps discussed herein. For example, the event detection instructions 625 may include instructions for computing a first score corresponding to an event at a first host based on a first timestamp of the event, a second timestamp, and a base rate. The event detection instructions 625 may include instructions for computing, based on the first score exceeding a first threshold value, a second score based on: the first timestamp, a third timestamp corresponding to an occurrence of the event at a second host, and the base rate. The event detection instructions 625 may include instructions for outputting an indication of the event based on the first score and the second score.

The data storage device 618 may include a machine-readable storage medium 628 that stores the event detection instructions 625 (e.g., software) embodying any one or more of the methodologies of functions described herein. The event detection instructions 625 may also reside, completely or at least partially, within the main memory 604 or within the processing device 602 during execution thereof by the computer system 600; the main memory 604 and the processing device 602 also constituting machine-readable storage media. The event detection instructions 625 may further be transmitted or received over a network 620 via the network interface device 608.

While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “computing,” “calculating,” “inputting,” “outputting,” “providing,” “detecting,” “identifying,” “obtaining,” “transmitting,” “receiving,” “determining,” “combining,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission, or display devices. Also, the terms “first,” “second,” “third,” “fourth” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
computing a first score corresponding to an event at a first host based on a first timestamp of the event, a second timestamp, and a base rate;
computing, based on the first score exceeding a first threshold value, a second score based on: the first timestamp, a third timestamp corresponding to an occurrence of the event at a second host, and the base rate; and
outputting, by a processing device, an indication of the event based on the first score and the second score.

2. The method of claim 1, wherein the second timestamp corresponds to at least one of:
a second occurrence of the event at the first host,
a time at which the first host was activated, or
a time at which an event detection system was activated.

3. The method of claim 1, further comprising:
detecting an occurrence of the event at the first host, wherein the computing the first score corresponding to the event is based on the detection.

4. The method of claim 3, further comprising:
obtaining an event stream comprising a type of the event, an identifier of the first host, and an identifier of an organization to which the first host belongs; and
determining that the event has occurred previously at the first host based on the event stream and a repository comprising indications of events, wherein the computing the first score is based on the determination that the event has occurred previously at the first host.

5. The method of claim 4, further comprising:
determining that the event has occurred previously at the second host based on the event stream and the repository comprising the indications of the events, wherein the computing the second score is based on the determination that the event has occurred previously at the second host.

6. The method of claim 1, further comprising:
computing a difference based on the first timestamp and the second timestamp, wherein the computing the first score comprises computing the first score based on the base rate and the difference.

7. The method of claim 6, wherein the computing the first score comprises computing a logarithm of a quotient of the difference and the base rate.

8. The method of claim 1, further comprising:
combining the first score and the second score to generate a combined score, wherein the outputting the indication of the event comprises outputting the indication of the event based on the combined score.

9. The method of claim 8, wherein the outputting the indication of the event comprises outputting the indication of the event based on the combined score exceeding a second threshold value.

10. The method of claim 1, further comprising:
computing a difference based on the first timestamp and the third timestamp corresponding to the occurrence of the event at the second host, wherein the computing the second score comprises computing the second score based on the base rate and the difference.

11. The method of claim 10, wherein the computing the second score comprises computing a logarithm of a quotient of the difference and the base rate.

12. The method of claim 1, wherein outputting the indication of the event comprises:
transmitting the indication of the event for presentation in a user interface (UI).

13. The method of claim 1, wherein the event comprises an indicator event or a detect event.

14. The method of claim 1, wherein the first host comprises at least one of a server or a user device.

15. The method of claim 1, wherein the first host and the second host belong to an organization.

16. The method of claim 1, wherein the first score is indicative of a recentness of the event occurring at the first host, and wherein the second score is indicative of a recentness of the event occurring with an organization.

17. A system, comprising:
a processing device; and
a memory to store instructions that, when executed by the processing device, cause the processing device to:
compute a first score corresponding to an event at a first host based on a first timestamp of the event, a second timestamp, and a base rate;
compute, based on the first score exceeding a first threshold value, a second score based on: the first timestamp, a third timestamp corresponding to an occurrence of the event at a second host, and the base rate; and
output an indication of the event based on the first score and the second score.

18. The system of claim 17, wherein the first score is indicative of a recentness of the event occurring at the first host, and wherein the second score is indicative of a recentness of the event occurring with an organization.

19. A non-transitory computer readable medium, having instructions stored thereon which, when executed by a processing device, cause the processing device to:
compute a first score corresponding to an event at a first host based on a first timestamp of the event, a second timestamp, and a base rate;
compute, based on the first score exceeding a first threshold value, a second score based on: the first timestamp, a third timestamp corresponding to an occurrence of the event at a second host, and the base rate; and
outputting, by the processing device, an indication of the event based on the first score and the second score.

20. The non-transitory computer readable medium of claim 19, wherein the first score is indicative of a recentness of the event occurring at the first host, and wherein the second score is indicative of a recentness of the event occurring with an organization.
